(19) United States
(12) Patent Application Publication
(10) Pub. No.: US 2009/0038466 A1
(43) Pub. Date: Feb. 12, 2009

(54) KEY FOR A MUSIC INSTRUMENT AND METHOD FOR MANUFACTURING THE SAME

(76) Inventor: Udo Elliger, Frankfurt (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/185,186

(22) Filed: Aug. 4, 2008

Related U.S. Application Data
(60) Provisional application No. 60/954,069, filed on Aug. 6, 2007.

(30) Foreign Application Priority Data
Aug. 6, 2007 (DE) 10 2007 036 857.9

(51) Int. Cl. G10C 3/12

(52) U.S. Cl. 84/433; 84/438; 84/439

(57) ABSTRACT

The invention relates to a key for pianos, comprising a pivotably supported key body consisting of a soft wood and adjustment means for adjusting the touch load of the key. A plate-shaped element of a different specific weight is inserted into the key body. The position and weight of the plate-shaped element is selected such that a desired touch load of the key is almost accomplished. The weight of the plate-shaped element is varied slightly by inserting an additional weight, in particular a setscrew, or by forming a recess in such a manner that the desired touch load of the key is accomplished. The plate-shaped element consists of a composite wood material comprising a press-formed resin-wood layer formed of wood veneer layers, which are impregnated with a resin under a vacuum and glued to each other while applying pressure and heat to accomplish a very high specific weight.

### RELATED APPLICATION

The present application claims priority of U.S. provisional patent application Ser. No. 60/954,069 “Key For a Music Instrument and Method for Manufacturing the same”, filed on Aug. 6, 2007, the whole content of which is hereby incorporated by reference. The present application corresponds to German patent application no. 10 2007 036 857.9 “Key For a Music Instrument and Method for Manufacturing the same”, filed on Aug. 6, 2007, now granted as German patent no. 10 2007 036 857.

### TECHNICAL FIELD

The present invention relates in general to keys for music instruments and methods for manufacturing the same and relates in particular to the adjustment of a predetermined touch weight or touch load of a key for keyboard instruments, particularly for the mechanism of grand pianos or acoustic pianos.

### BACKGROUND

The adjustment of a predetermined touch load is very important for accomplishing a desired touch feeling with acoustic pianos or grand pianos. For this purpose it is known to dispose two or more weights, usually consisting of lead, in the front end of a key (in the following also front end key), with fixed connection relative to the respective key, which weights form the counter-weights to the part of the mechanism resting on the rear lever and define the predetermined touch load, e.g. a touch load of 45 grams or 50 grams. The number and position of the lead members to be inserted into the key for this purpose is variable and is respectively determined by a piano technician in the factory. The costs for this particular job are rather high.

FIG. 1 shows particulars of this conventional approach. More specifically, FIG. 1 shows a key 100 on which also the approach according to the present invention shall be applied. According to FIG. 1, the key 100 comprises an elongated, rectangular key body 102, which consists of a softwood, e.g. of spruce wood or pine wood, and which has a relatively small weight. In the front region the key body 102 is covered by an L-shaped key cover 104, which is e.g. of acrylic. A middle plate 105 is adhered in a central region on the top of the key body 102 and a balance pin hole 106 extends through these members in vertical direction. This balance pin hole 106 is engaged with an upright balance pin (not shown) to swingably support the key. Furthermore, the key body 102 is provided in the known manner with a front pin hole 114 in a front edge region of the bottom face thereof, which is engaged with an upright front pin (not shown) to prevent horizontal deflection of the key 100. A capstan screw 108 is attached at a position behind the balance pin hole 106 on the top face of the key body 102 through a capstan plate 107. An action (not shown) is supported on this capstan screw 108. With the foregoing configuration, when a front portion of the key 100 is pressed downward, the key 100 swings about the balance pin (not shown) causing the capstan screw 108 to push up the action for its actuation. The so-called touch load of the key is determined by the balance of a moment produced by the weight of the action and the key 100 about the balance pin.

According to FIG. 1, for adjusting or regulating the touch load conventionally a plurality of boreholes 109 are formed in the front side face of the key body 102, into which cylindrical lead members 110 are inserted and caulked in the known manner. The position of the boreholes 109 is variable, in correspondence with the desired touch load.

This approach is elaborate and costly and not up to date for environmental reasons due to the usage of lead as material of high specific weight.

FIG. 2 shows an alternative approach according to the prior art, as disclosed e.g. in DE 102 33 001 A1 or corresponding U.S. Pat. No. 6,774,294 B2. A plurality of embedding holes 109 are disposed at predetermined positions on the front side face of the key body 102 spaced apart to the balance pin hole 106 and at a predetermined spacing relative to each other. Cylindrical threaded pins 110 having an external thread 113 are used, which are made of a material other than lead, preferably of iron. The threaded pins 110 of a predetermined diameter and of a predetermined length are screwed into the embedding holes 109 for adjusting a desired touch load, using a screwdriver. This approach, however, bears the risk of crack formation in the softwood material of the key body 102. Namely, in order to prevent warping of the key member 102, the fibre direction of the softwood material of the key body 102 extends in parallel with the bottom side of the key body 102. This is indicated in FIG. 2 by two lines 124, which are to designate in an exemplary manner the fibre direction of the softwood material. Even though the embedding holes 109 are formed within the softwood material with a diameter slightly smaller than the diameter of the external thread 113 of the capstan screw 110, screwing in the capstan screws 110 in the direction of the fibre planes of the softwood material of the key body 102 causes the individual fibre planes of the softwood material to be pushed away from each other upon screwing-in of the capstan screws, which is detrimental due to the known cracking proneness of such softwood materials. This cracking is aggravated significantly, if the key mechanism is stored under humidity which is too low.

When fine-tuning a keyboard, the piano technician is demanded to show a sure instinct so that fine-tuning is still rather elaborate. As can be derived from FIG. 2, a plurality of adjusting weights are still required for adjusting a predetermined touch load, which increases the risk of crack formation further. Overall, the aforementioned approach is thus of limited use only for the industrial manufacturing of keyboards and represents a significant expense factor; but still a certain percentage of defective keys has to be taken into account due to the aforementioned crack formation.

U.S. Pat. No. 6,531,651 B2 discloses a similar approach. As an alternative to usage of adjustment weights DE 1 064 325 B discloses a key comprising a groove-shaped recess in the front portion of the key extending in the longitudinal direction of the key, a weight for adjusting the touch load being supported movable in longitudinal direction on a threaded spindle within a frame corresponding to the groove-shaped recess, a regulating shaft being provided for enabling a displacement of the weight, said regulating shaft preferably acting onto the threaded spindle via bevel gears. Also this approach is elaborate and is only of limited use for manufacturing keyboards on an industrial scale.

DE 102 48 000 A1 (corresponding to U.S. Pat. No. 6,693,235 B2) discloses an alternative approach for reducing the risk of breakage of the key body. An additional front plate is put onto the key body, into which an adjustment weight is inserted. An insert hole is formed in the key body, which extends in vertical direction through a front plate up to the key body. An adjustment weight, which consists of a material other than lead, is inserted into the insert hole by a press-fit and attached to the key body. While the key body is formed of a softwood material, the front plate is formed of a harder and hence heavier wood. With this configuration also a certain adjustment of the touch load of the key is accomplished. For geometrical reasons, however, the adjustment weight can only be attached behind the balance point of the key body, which is not so convenient for the adjustment of the touch load due to the lever arms prevailing. Also this approach is only of limited use for the manufacturing of keyboards on an industrial scale.

DE 1 244 541 B1 discloses a method for attaching a key cover to a key body. U.S. Pat. No. 5,585,582 discloses an automatic method for adjusting the touch load of keys of a grand piano.

### SUMMARY

It is an object of the present invention to provide a key for music instruments, in particular for acoustic pianos or grand pianos, which can be manufactured in a cost-efficient manner and using industrial processing techniques, and wherein the touch load (touch weight) can be adjusted easily and in a cost-efficient manner. According to further aspects of the present invention there is also to be provided a method for manufacturing such a key and a method for adjusting the touch load (touch weight) of such a key.

Thus, the present invention relates to a key for a music instrument, comprising a key body, which is pivotably or swingably supported, and adjustment means for adjusting or regulating a touch load (touch weight) of said key. According to the present invention the adjustment means comprises a plate-shaped element, which is inserted into said key body or is connected with said key body, the specific weight of said plate-shaped element being different to that of said key body. According to the present invention the plate-shaped element is a multi-layer composite wood material, wherein at least one adjustment weight is inserted into said plate-shaped element and/or at least one recess is formed within said plate-shaped element to thereby adjust said touch load of said key.

According to the present invention, the plate-shaped element substantially serves to enable a coarse adjustment of the touch load so as to be almost equal to the desired touch load, which is e.g. specified by a particular manufacturer of pianos or grand pianos. The additional adjustment weight or the additional recess represents a supplemental measure of a relatively small impact for precisely adjusting the desired touch load. According to the present invention only a relatively small weight variation in a region spaced apart to the balance point of the key body is necessary for this purpose, so that according to the invention less adjustment weights or adjustment recesses are sufficient to enable a precise adjustment of the touch load. Particularly preferably according to the present invention only a single recess or a single adjustment weight is provided within the plate-shaped element.

The material of the plate-shaped element and the physical and mechanical characteristics thereof are parameters that can be varied easily to enable an appropriate adjustment of the weight distribution of the key body, optimizing production engineering aspects, e.g. the joining with the softwood material of the key body and a substantial reduction of the aforementioned risk of crack formation, for which purpose the configuration of the front end of the key body can be modified.

Preferably, the plate-shaped element comprises uniform side faces that are preferably regularly formed so that the plate-shaped element can be inserted easily into the key body using wood processing machines and simple industrial processing steps.

Overall the approach according to the present invention turns away from conventional principles, according to which a plurality of relatively small but heavy adjustments weights had to be inserted at positions that had to be determined individually for enabling an adjustment of the touch load. In comparison to the prior art the plate-shaped element according to the present invention is rather long in the longitudinal direction of the key body so that according to the present invention the weight distribution of the key body can be varied not only locally but in a rather large-area portion.

Even more preferably the plate-shaped element is formed of a composite wood material, whose organically grown fibre structure has been removed completely. In particular, such composite wood materials can be formed on an industrial scale with reproducible properties. In particular, the specific weight can be precisely set for such a composite wood material.

According to a further embodiment the plate-shaped element is a rectangular plate, in particular a cuboid, which extends in the longitudinal direction of the key body and is disposed on only one side of the balance point of the key body and spaced apart therefrom. It is of advantage that the rectangular plates can be inserted precisely into the softwood material of the key body or attached to the front end of the key body using simple industrial processing steps. Basically, the position of the plate-shaped element does not have to be specified with high precision, because according to the present invention the touch load is precisely adjusted by an additional measure, namely the adjustment weight or the recess.

The plate-shaped element is flush with the bottom side and side faces of the key body. In general, the external appearance of such a key is not different as compared to conventional key, which is also an important precondition for the replacement during the manufacturing of conventional keyboards or repairing of existing keyboards.

Preferably, the plate-shaped element is formed of a wood material, wherein the organically grown, fibrous structure does not exist anymore so that the afore-mentioned risk of crack formation does not exist anymore. Thus, adjustment weights can be engaged with or inserted into the plate-shaped element regardless of the orientation relative to the plate-shaped element and without the risk of crack formation. Thus, according to the present invention the respective adjustment weight can be engaged with under arbitrary angles and orientations and in general at any side face of the plate-shaped element.

Particularly preferably the plate-shaped element is formed of a composite wood material, because the organically grown, fibrous structure is completely removed in such a composite wood material. In particular, composite wood materials can be produced on an industrial scale with reproducible characteristics. In particular is it possible to precisely adjust the specific weight of such a composite wood material.

Preferably, the composite wood material is a multi-layer composite wood material, which can comprise e.g. a press-formed resin-wood layer, which is formed of wood veneer layers which are layered lengthwise, cross-wise, star-like or the like relative to each other. These veneer layers can be impregnated, e.g. using a vacuum method, and can be glued by means of curable resins under pressure and heat. In this manner composite wood materials having a relatively high specific weight can be produced, which also exhibit substantially the characteristics of wood, i.e. which naturally mate to the softwood environment in the key body and thus enable a durable joining with the softwood material of the key body. Particularly high specific weights can be accomplished using hardwood materials, such as beech wood, maple wood, oak tree wood or the like, for forming the composite wood material.

According to a further embodiment preferably so-called Panzerholz® from Delignit® is used as the composite wood material. Such composite wood materials are characterized by a relatively high specific weight and by a high hardness and durability.

Of course, the composite wood material generally may comprise also layers of different materials, such as thin metal sheets, ceramic layers, mineral layers or the like, for enabling the setting of an even higher specific weight and the additional variation of the mechanical properties of the composite wood material.

Generally, the present invention is, however, not limited to usage of wood materials or composite wood materials for the plate-shaped element. Generally the plate-shaped element generally may consist of any other material, such as metal sheets, metal foams, ceramic or metal sintered members or the like, so that the specific weight and the mechanical properties of the plate-shaped element may be varied according to the present invention within wide-ranged limits. Preferably, according to the present invention only a single plate-shaped element is inserted in or engaged with the key body, which is of advantage for costs reasons and production engineering reasons. Conveniently, the plate-shaped element is joined with the softwood material of the key body using an appropriate non-positive joining, connections with force transmission by friction and/or adhesive bonding. Dovetail connections, toothings, so-called lap connections or also so-called shifting-connections turned out to be particularly convenient.

Even more preferably only a single weight is inserted into the plate-shaped element or only a single recess is formed therein. As the weight distribution of the key body can already be adjusted by means of the plate-shaped element in such a manner that the desired touch load is almost accomplished, according to the present invention only relatively marginal variations of the weight or weight distribution of the plate-shaped element are required for the precise adjustment of the touch load, for which purpose generally only a single adjustment weight or a single recess is sufficient.

According to the present invention nearly arbitrary materials can be used for the precise adjustment of the touch load, even materials having a lower specific weight. Thus, use of lead or lead alloys can be dispensed with completely. Conveniently, according to the present invention the adjustment weight is formed as a threaded pin or set screw, e.g. as an Allen threaded pin or as a recessed threaded pin, which is screwed into the plate-shaped element at a predetermined position from a side or from the bottom side of the key body.

According to a further embodiment, the respective adjustment weight, particularly the threaded pin, consists of a hard metal, in particular of a sintered carbide hard metal. Hard metals, which are composite materials, are characterized besides by a very high hardness, wear-resistance and a particularly high warm hardness also by a high specific weight. Hard metal consists mostly of 90-94% tungsten carbide (reinforcement) and 6-10% cobalt (matrix), wherein the grains of tungsten carbide are of a size 0.5-1 microns in average and wherein the cobalt fills interstices. Sintering resides in that a hard material having a high melting temperature, i.e. carbide, is mixed, in a finely dispersed state, with a second material (supplementary body) having a lower melting temperature and heated to temperature below the melting temperature of the carbide, temperature and duration of the heating step being chosen such that the carbides agglomerate. Besides conventional hard metals on the basis of tungsten carbide, also hard metals, which comprise only titan carbide or titan nitride as hard materials, may be used, wherein the binding phase consists e.g. of nickel, cobalt and molybdenum (also called Cermets (ceramic+metal). Generally, according to the present invention also cast hard metal can be used.

According to a further aspect of the present invention, the adjustment weight is glued into the plate-shaped element so that the adjustment weight is not necessarily formed as a threaded pin.

A further aspect of the present invention relates to a method for manufacturing a key for music instruments, in particular for acoustic pianos or grand pianos. At first a rectangular plate of a soft wood material is provided, e.g. of pine wood or spruce wood. Afterwards, a recess is formed near a front end of the rectangular plate, which extends along a first direction of said rectangular plate, preferably in parallel with a longitudinal edge of said rectangular plate, e.g. by milling a profiled recess. Afterwards, a correspondingly formed plate-shaped element is inserted into or engaged with said recess, said plate-shaped element having a specific weight which is different to the specific weight of said soft wood material. Finally, a plurality of key bodies are cut from said rectangular plate by cutting along a second direction perpendicular to said first direction, e.g. by laser cutting.

Thereby the weight of the plate-shaped element is designed such that the desired touch load of the key is almost reach or exceeded only slightly. Thus, for the precise adjustment of the touch load only a marginal modification of the weight or of the weight distribution of the plate-shaped element is necessary, as described above.

As an alternative to inserting or engaging a plate-shaped element the latter can also be joined with the plate-shaped element of softwood material in the region of the front face and along said first direction of said plate-shaped element. For this purpose, generally any connections with force transmission by friction, a non-positive joining, positive-fitting and/or adhesive bonding techniques are suitable.

A further aspect of the present invention relates to a method for the preferably automatic adjustment of the touch load of a key produced in such a manner, which is pivotably supported about a balance point. Further details of such a method shall be described in the following referring to the drawings.

### BRIEF DESCRIPTION OF DRAWINGS

Hereinafter the invention will be described in exemplary manner and with reference to the accompanying drawings, from which further features, advantages and problems to be solved may be derived, wherein:

FIG. 1 shows the key of a grand piano according to the prior art having lead weights for adjustment of the touch load;

FIG. 2 FIG. 2 shows another key of a grand piano according to the prior art of a lead-free material for adjustment of the touch load;

FIG. 3 is a schematic partial cross section of a key according to a first embodiment of the present invention;

FIG. 4 is a schematic partial cross section of a key according to a second embodiment of the present invention;

FIG. 5 is a schematic partial cross section of a key according to a third embodiment of the present invention;

FIG. 6 is a schematic partial cross section of a key according to a fourth embodiment of the present invention;

FIG. 7 is a schematic partial cross section of a key according to a fifth embodiment of the present invention;

FIG. 8 is a schematic bottom view of a key according to another embodiment of the present invention;

FIG. 9 is a schematic plan view of a rectangular plate of a softwood material and having a material insert for manufacturing of a key according to the present invention; and

FIG. 10 is a schematic flow diagram of a method according to the invention for adjustment (preferably automatic adjustment) of the touch load of a key according to the present invention.

Throughout the drawings, identical reference numerals designate identical or substantially equivalent elements or groups of elements.

### DETAILED DESCRIPTION

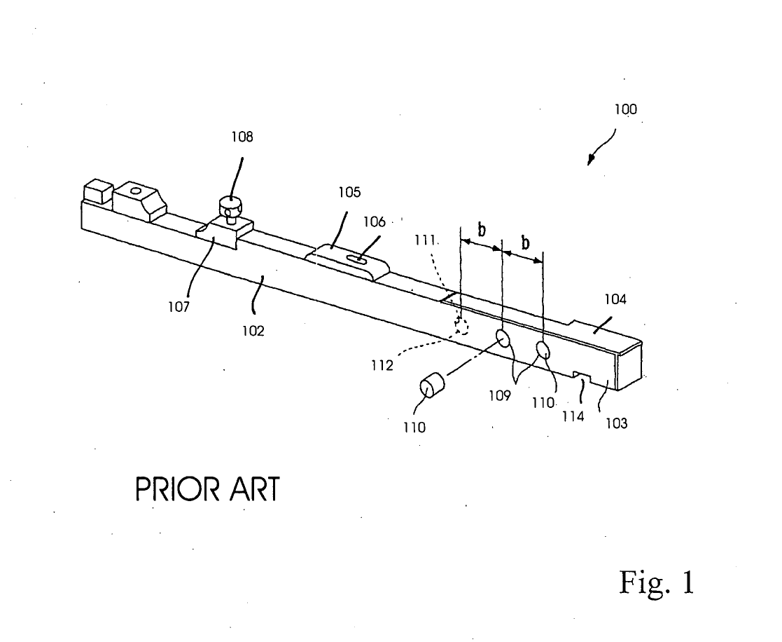

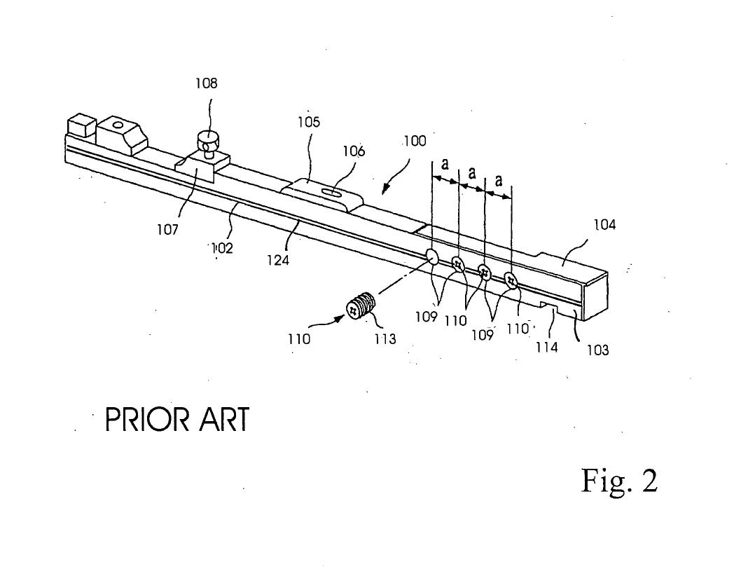

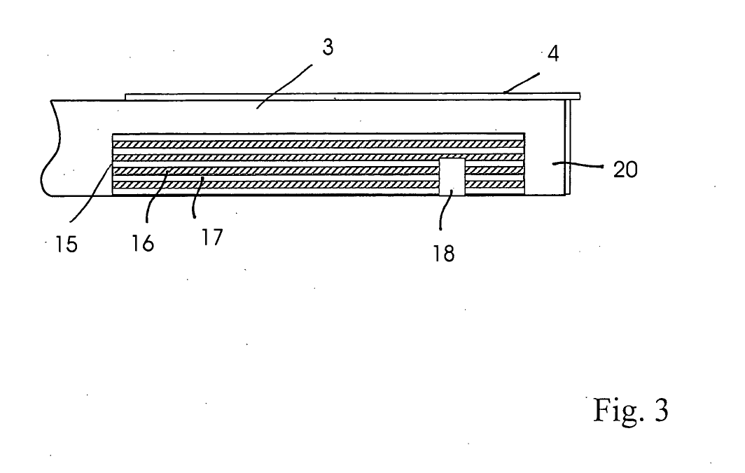

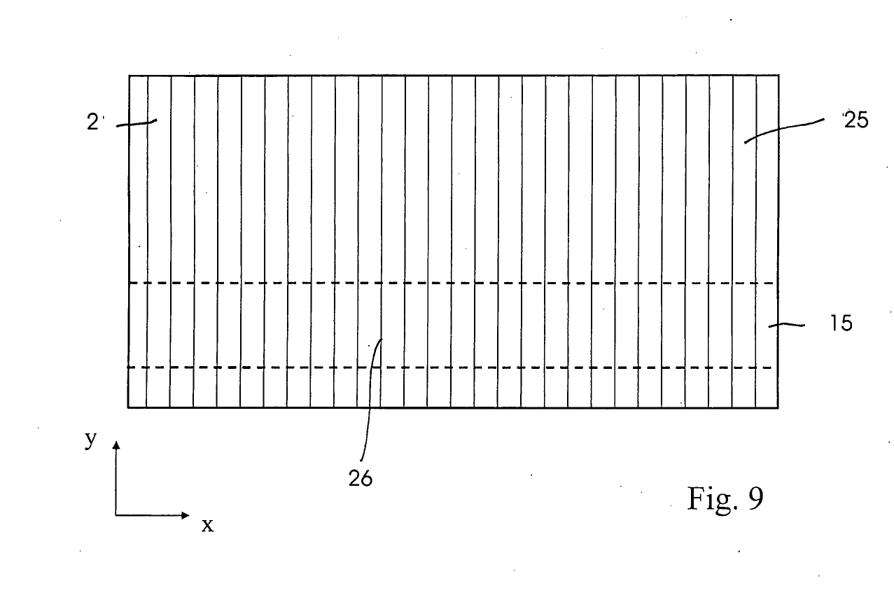

FIG. 3 shows in a partial cross-section the front end 3 of a key having an overall configuration, which is essentially similar to that described above with reference to FIGS. 1 and 2. According to FIG. 3 a material insert 15 is inserted into the front end 3 of the key, said material insert 15 being formed as a rectangular plate. The material insert 15 extends in a direction perpendicular to the plane of drawing of FIG. 3, preferably over the entire width of the front end 3 of the key. The material insert is inserted into a recess of corresponding shape, which is formed within the front end 3 of the key. This can be accomplished e.g. by performing a milling process, as will be described with reference to FIG. 9 below. The material insert 15 is glued in the front end 3 of the key and is flush with the rear side and the side faces of the front end 3 of the key.

According to FIG. 3 the material insert 15 according to the present invention consists of a wood composite material comprising a plurality of material layers 15, 16 having different characteristics, which are disposed in an alternating manner. The plurality of material layers 16, 17 together form a multi-layer wood composite material which has a different specific weight as compared to that of the soft wood material of the front end 3 of the key. The individual layers 16, 17 can be veneer layers that are glued to each other under pressure, preferably of hard wood such as beech tree, maple tree or oak tree, which are layered lengthwise, crosswise or star-like or in an arbitrary other suitable manner. Such veneer layers can be impregnated under vacuum conditions with curable resins and can be glued together by curable resins under high pressures and high temperatures. A preferable wood composite material is so-called Panzerholz® commercially available from Delignit®. Such wood composite materials are available with specific weights e.g. in the range between 0.9 and 1.4 g/cm³.

The shape, weight and position of the material insert 15 is selected such that the touch load (touch weight) of the key, if the insert is inserted into the key, differs but slightly from the desired touch load, e.g. by ±20%, more preferably by ±10% and even more preferably by ±5%. The actual touch load caused by the material insert can be slightly higher or lower than said desired touch load. In order to precisely adjust the desired touch load, according to FIG. 3 a setscrew or threaded pin 18 of a lead-free material, e.g. of a metal different from lead or of a lead-free alloy, is screwed into the material insert 15. Position and weight of the setscrew 18 precisely defines the touch load. If the desired touch load is exceeded due to the material insert, it is possible to provide a recess instead of the setscrew 18 as an alternative.

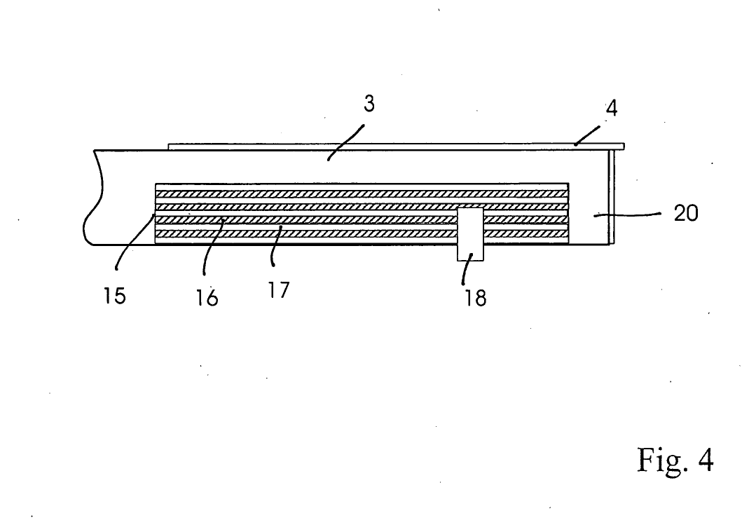

FIG. 4 shows an alternative embodiment, wherein the threaded pin 18 slightly protrudes from the bottom side of the key body. According to FIGS. 3 and 4 the threaded pin 18 is screwed into the material insert 15 perpendicularly to the layer sequence 16, 17. As an alternative, the threaded pin 18 can also be screwed in from the side face of the key body, i.e. along the individual layers 16, 17. Even in the latter case this does not result in crack formation within the material insert 15, because the organically grown fibre structure is broken due to the material composite. In any case the formation of cracks within the softwood materials of the front end 3 of the key body can be prevented.

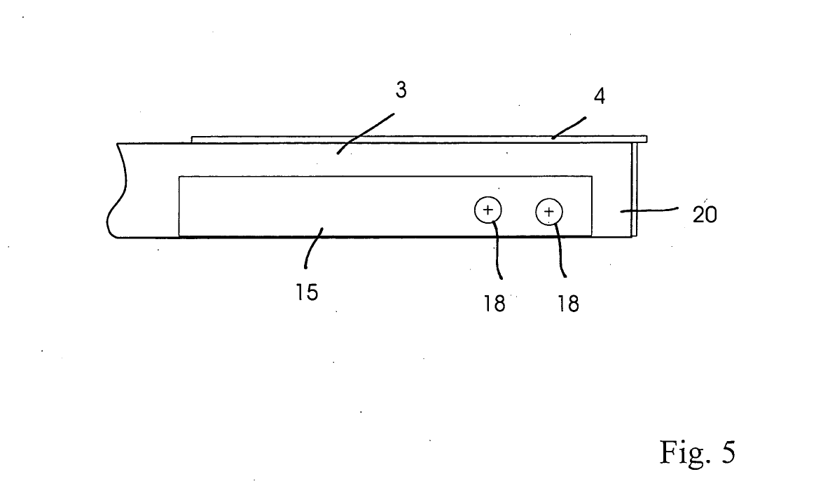

As shown in FIG. 5, generally also plural threaded pins 18 can be used for a precise adjustment of the touch load. These may be screwed in at regular distances relative to each other or at positions that can be predetermined in an arbitrary manner.

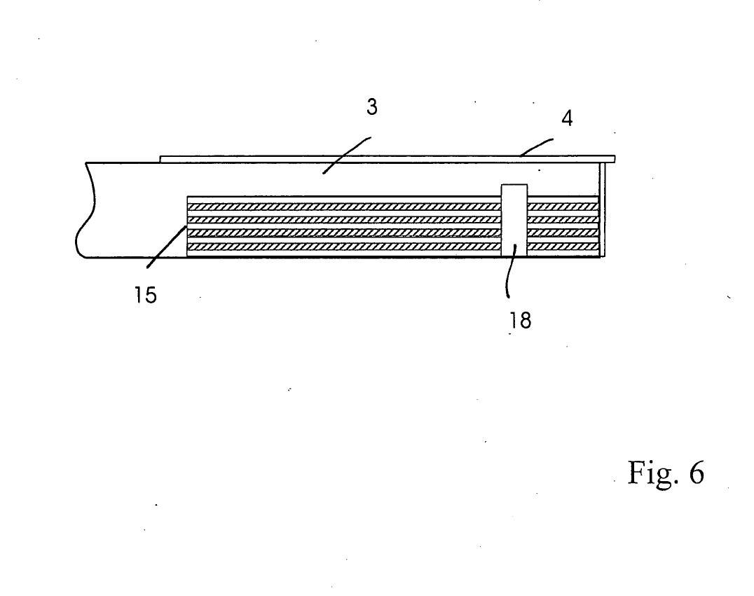

FIG. 6 shows an alternative embodiment, according to which the threaded pin 18 runs completely through the material insert 15 and extends up to the softwood material of the front end 3 of the key body. It is expressly noted that also in this case the threaded pin 18 only serves to enable the attachment of the material insert 15 in the softwood material of the front end 3 of the key body.

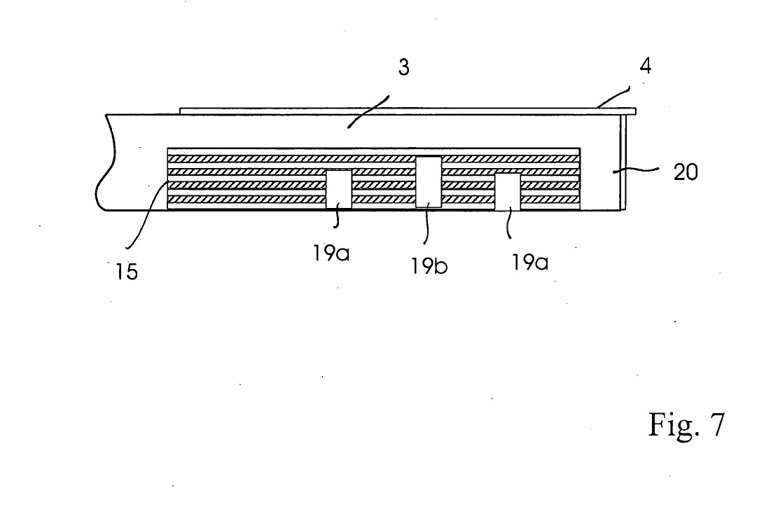

FIG. 7 shows an alternative embodiment, according to which the predetermined touch load is exceeded due to the material insert 15. Thus, plural recesses 19a, 19b are disposed within the material insert 15 for the precise adjustment of the touch load. These can be disposed at regular distances relative to each other or at positions that can be predetermined in an arbitrary manner. The depth and/or diameter of the recesses 19a, 19b can be identical or different.

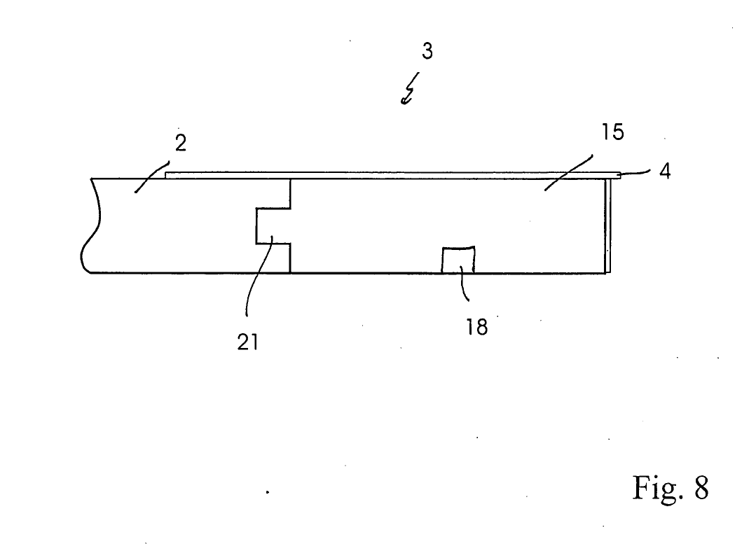

FIG. 8 shows a further embodiment, according to which the front end of the key body 2 is completely formed of a material 15, which is different to the softwood material. According to FIG. 8, the block 15 is joined with the key body 2 using a dovetail-connection 21. As an alternative, arbitrary toothings, gluing or adhesive bonding or so-called shifting connections are used.

In the following we refer to FIG. 9 for the manufacturing of a key according to the present invention. According to FIG. 9, firstly a rectangular plate 25 is formed of a suitable softwood material. The section-shape of this softwood plate 25 can already be matched with the section-shape of the key body 2 (see FIGS. 1 and 2). Afterwards, a recess, which extends over the entire width, i.e. extending in x-direction, is formed in the rearside of the softwood plate 25, e.g. by milling a channel having an appropriate profile. In particular, this channel can be of a rectangular or trapezoidal profile or can have any other profile. A material insert 15 of a corresponding shape or profile and of a different specific weight is engaged with or inserted into the afore-mentioned recess and joined with the softwood material in a suitable manner, preferably by gluing, by means of toothings, dovetail-connections, shifting-connections or combinations of the afore-mentioned joining techniques. In a final step the individual key bodies are cut from the plate 25 by cutting along the y-direction, i.e. perpendicular to the x-direction, e.g. by sawing or laser cutting.

As will be easily apparent to the person skilled in the art, the afore-mentioned recess may also extend up to the front edge of the softwood plate 25. As an alternative, a material block 15 of an appropriate cross-section may also be joined with the front face of the softwood plate 25 using appropriate joining techniques, as described above. Preferably, the weight of the aforementioned material insert 15 or of the material block 15 is such in order to impart a touch load to the key which is close to the desired touch load, if said key is pivotably supported in a corresponding mechanism.

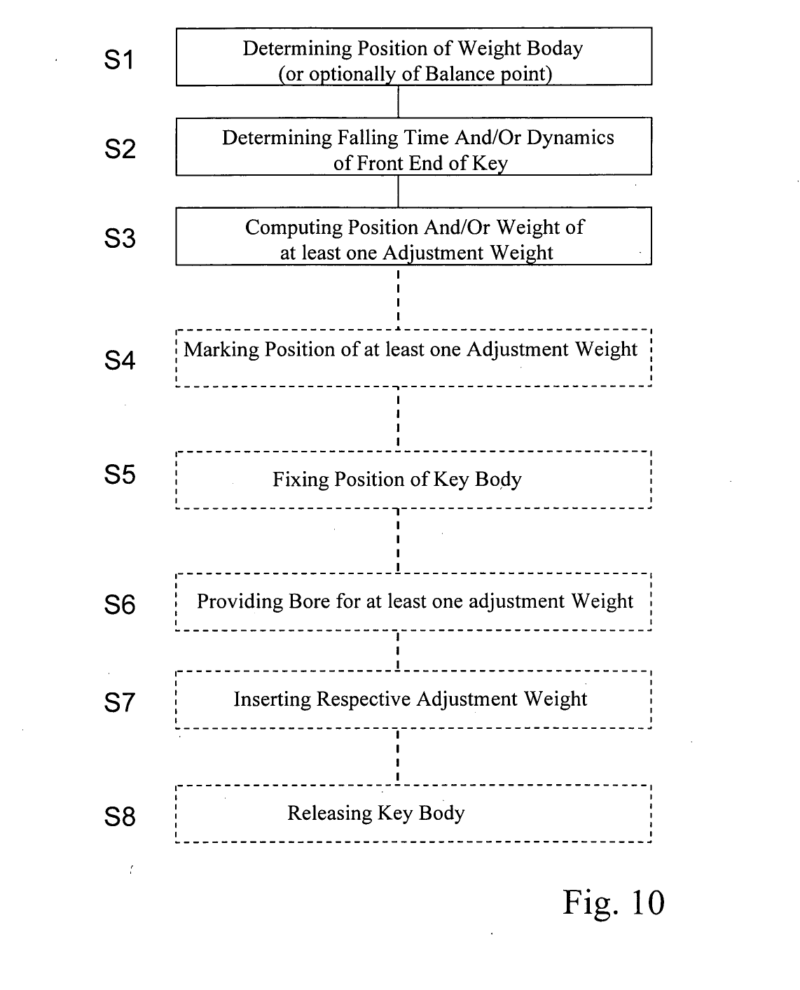

The key according to the present invention is suited for the automatic adjustment of the touch load, because by means of the material insert the touch load of the key can be set close to the desired touch load. For such an automatic method reference is made in the following to FIG. 10. Therein, steps S1 to S3 refer to the indispensable method steps, whereas steps S4 to S8 refer to optional individual or plural method steps to be additionally performed. It is assumed that the key is already installed in a normal mechanism. In step S1 a weight member having a predetermined weight is put on the key at a predetermined position. The position of the weight member is determined, preferably by an optical or optoelectronic method. For the following explanation it is assumed that the touch load is not yet exceeded due to the material insert, i.e. that an additional adjustment weight is to be engaged with said material insert.

In step S2 the falling time and/or falling dynamics of the front end of the key body is determined, preferably by an optical or optoelectronic method. From the falling time and/or falling dynamics of the key body, which has been determined in such a manner, and taking into account the position and weight of the weight member the position and/or weight of the adjustment weight to be inserted into the material insert is computed (step S3). Finally, the adjustment weight is engaged with the material insert at the such determined position, in particular by screwing (step S7).

Therein, the position of the adjustment weight to be inserted can be marked, e.g. by writing, boring or laser marking a side face of the key body (step S4). Before attaching the adjustment weight, the key body may be retained according to step S5, e.g. by means of a grasping arm or by means of manually or automatically adjustable clamping blocks. Afterwards, a pilot hole can be formed in the material insert (step S6). This pilot hole can be formed manually by the technician (for which purpose the afore-mentioned marking is of advantage), but can also be formed automatically. Size and position of the pilot hole are matched to the adjustment weight to be inserted, which has been computed in step S3. Afterwards, an adjustment weight having the weight computed in step S3 is inserted at the position, which was computed in step S3, in step S7, i.e. into the pilot hole. Finally, the key body is released again in step S8. Although not shown in FIG. 10, this cycle can be followed up by a further cycle, including determining the touch dynamics of the key body. Afterwards the touch load of the key body can be varied in the further cycle by further adjustment of the adjustment weight, by inserting a further adjustment weight, by replacement of the adjustment and/or by appropriately designing a recess of the material insert. Of course, further cycles may follow up this cycle. Further details of such a method for automatically adjusting the touch load, reference is made to U.S. Pat. No. 5,585,582, the whole contents of which is hereby incorporated by reference.

As will become apparent to the person skilled in the art, the afore-mentioned aspects according to the present invention can be combined in an arbitrary manner. As will be easily apparent to the person skilled in the art, as an alternative to the purposeful loading of the front end of the key body by means of a material insert having a higher specific weight also a purposeful weight reduction of the front end of the key body by means of a material insert having a smaller specific weight can be used for the adjustment of the touch load of the key close to the desired touch load. As will become apparent to the person skilled in the art, a further more common aspect of the present invention relates to the use of a multi-layer composite wood material, as described above, for manufacturing a key body for acoustic pianos and in particular for grant pianos.

What is claimed and is desired to be secured by U.S. Letters Patent is:

1. A key for a music instrument, comprising a key body, which is pivotably or swingably supported, and adjustment means for adjusting or regulating a touch load of said key,
said adjustment means comprising a plate-shaped element, which is inserted into said key body or is connected with said key body, wherein
a specific weight of said plate-shaped element is different to that of said key body;and
at least one weight is inserted into said plate-shaped element and/or at least one recess is formed within said plate-shaped element to thereby adjust said touch load of said key.

2. The key as claimed in claim 1, wherein said plate-shaped element is a rectangular plate, which extends lengthwise along said key body and is disposed in its entirety on one side of and spaced apart to a balance point of said key body.

3. The key as claimed in claim 2, wherein said plate-shaped element is flush with a bottom side and side faces of said key body.

4. The keys as claimed in claim 1, where said plate-shaped element is formed of a multi-layer wood composite material.

5. The key as claimed in claim 4, wherein said multi-layer wood composite material comprises a press-formed resin-wood layer, which is formed of wood veneer layers which are layered lengthwise, cross-wise or star-like.

6. The key as claimed in claim 5, wherein said wood veneer layers are impregnated with a resin under a vacuum and are glued to each other by means of resins while applying pressure and heat.

7. The key as claimed in claim 1, wherein said adjustment means comprises a single plate-shaped element.

8. The key as claimed in claim 7, wherein the weight of said plate-shaped element is such that a touch load of said key is slightly lower or higher than said predetermined touch load.

9. The key as claimed in claim 8, wherein a single weight is inserted into said plate-shaped element or wherein a single recess is formed within said plate-shaped element.

10. The key as claimed in claim 1, wherein said adjustment weight is a setscrew, which is free of lead and is inserted into said plate-shaped element or extends therethrough.

11. The key as claimed in claim 10, wherein a respective setscrew engages into a side surface of said plate-shaped element in a perpendicular direction.

12. The key as claimed in claim 11, wherein said setscrew extends in parallel with a layer orientation of said plate-shaped element, which is formed as a multi-layer wood composite material.

13. The key as claimed in claim 10, wherein the respective adjustment weight consists of a hard metal.

14. The key as claimed in claim 1, wherein said plate-shaped element forms the entire front end of said key body.

15. A method for manufacturing a key for a music instrument, comprising the steps of:
providing a rectangular plate of a soft wood material;
forming a recess, which extends along a first direction of said rectangular plate, preferably in parallel with a longitudinal edge of said rectangular plate;
inserting a plate-shaped element into said recess, said plate-shaped element having a specific weight which is different to the specific weight of said soft wood material;
cutting a plurality of key bodies from said rectangular plate by cutting along a second direction perpendicular to said first direction.

16. A method for manufacturing a key for a music instrument, comprising the steps of:
providing a rectangular plate of a soft wood material;
connecting said rectangular plate with a plate-shaped element at the front end and along a first direction of said rectangular plate, said plate-shaped element having a specific weight which is different to the specific weight of said soft wood material; and
cutting a plurality of key bodies from said rectangular plate by cutting along a second direction perpendicular to said first direction.

17. In a method for adjusting the touch load of a key of a music instrument, which is pivotably or swingably supported about a balance point, comprising the steps of:
determining the position of a weight body put onto the key body of said key and having a predetermined weight or actuating said key body via a predetermined touch momentum or impetus;
determining the falling time and/or falling dynamics of said key body upon release or actuation thereof; and
computing the position and/or weight or size of at least one adjustment weight or of at least one recess within said plate-shaped element based on the time and/or dynamics and optionally on the position of said weight body;
using a key, which comprises adjustment means for adjusting or regulating a touch load of said key,
said adjustment means comprising a plate-shaped element, which is inserted into said key body or is connected with said key body, wherein
a specific weight of said plate-shaped element is different to that of said key body;
wherein said at least one adjustment weight is inserted or said at least one recess is formed within said plate-shaped element at said computed position and/or with said computed weight or said computed size.

18. The method as claimed in claim 17, wherein said position of said weight body is determined relative to said balance point.

19. The method as claimed in claim 18, wherein said computed position of said adjustment weight or of said recess is marked automatically.

20. The method as claimed in claim 19, wherein a mark is formed for marking using a laser beam, by drilling or writing of or onto a side of said plate-shaped element.
